(19) United States
(12) Patent Application Publication
(10) Pub. No.: US 2012/0097639 A1
(43) Pub. Date: Apr. 26, 2012

(54) CONTACT-HOLE FORMING METHOD

(75) Inventor: Kazuya Mitsudome, Osaka (JP)

(73) Assignee: SHARP KABUSHIKI KAISHA, Osaka (JP)

(21) Appl. No.: 13/382,184

(22) PCT Filed: Jun. 24, 2010
(86) PCT No.: PCT/JP2010/060740

§ 371 Date: Jan. 4, 2012

(30) Foreign Application Priority Data
Jul. 6, 2009 (JP) 2009-160096

(51) Int. Cl. B05D 3/10

(52) U.S. Cl. 216/37

(57) ABSTRACT

A contact hole forming method according to the present invention includes a process (a) of forming an insulating film on a substrate and a process (b) of forming a contact hole in the insulating film by etching. Here, the process (a) includes steps of (a1) placing the substrate between a pair of electrodes, (a2) supplying a first reaction gas between the pair of electrodes having the substrate placed therebetween in the step (a1), (a3) raising an RF output supplied between the pair of electrodes to a prescribed set value after the step (a2) so as to generate a plasma, and (a4) supplying a second reaction gas that forms the insulating film after the step (a3).

### TECHNICAL FIELD

The present invention relates to a contact hole forming method, and more particularly, to a process of forming a contact hole in an insulating film. The present application claims priority to Patent Application No. 2009-160096 filed in Japan on Jul. 9, 2009 under the Paris Convention and provisions of national law in a designated State. The entire contents of which are hereby incorporated by reference.

### BACKGROUND ART

In a circuit substrate such as a semiconductor device having a multi-layer wiring structure, for example, a contact hole is formed in an interlayer insulating film overlying a lower layer wiring line so that the lower layer wiring line and an upper layer wiring line are connected. Such a contact hole is desirably formed into a tapered shape, which opens wider on the side of the surface of the insulating film and bercomes gradually narrower toward the lower layer wiring line. A method of forming such a contact hole is disclosed in Japanese Patent Application Laid-Open Publication No. H9-251996 (Patent Document 1), for example. This publication discloses a technology to increase an etching rate of the insulating film stepwise or continuously as the position moves toward the surface layer portion by lowering the RF output stepwise or continuously in the plasma CVD film forming method used in the process of forming the insulating film.

### RELATED ART DOCUMENTS

### Patent Documents

Patent Document 1: Japanese Patent Application Laid-Open Publication No. H9-251996

### SUMMARY OF THE INVENTION

### Problems to be Solved by the Invention

When the interlayer insulating film is formed such that the etching rate becomes increasingly higher toward the surface layer portion, a tapered contact hole that narrows gradually toward an underlying drain wiring line can be appropriately formed in the etching process that is performed to form contact holes. Patent Document 1 discloses a technology to lower the RF output stepwise or continuously in the plasma CVD film forming method used in the process of forming an insulating film. The present invention discloses a new approach to the “contact hole forming method” for forming such contact holes, which makes it possible to form a tapered contact hole more reliably.

### Means for Solving the Problems

A contact hole forming method according to the present invention includes a process (a) of forming an insulating film on a substrate and a process (b) of forming a contact hole in the insulating film by etching. The process (a) of the above-mentioned contact hole forming method includes the steps of (a1) placing the substrate between a pair of electrodes, (a2) supplying a first reaction gas between the pair of electrodes having the substrate placed therebetween in the step (a1), (a3) raising an RF output supplied between the pair of electrodes to a prescribed set value after the step (a2) to generate a plasma, and (a4) supplying, after the step (a3), a second reaction gas that forms the insulating film. In this case, the second reaction gas that forms the insulating film is supplied to initiate the formation of the insulating film after the RF output has been raised to the prescribed set value. This allows the deep layer portion of the insulating film to have a desired etching rate.

In this case, the step (a4) of supplying the second reaction gas may also be followed by the step of forming the insulating film while increasing the distance between the pair of electrodes. This can ensure that the deep layer portion of the insulating film has a desired etching rate. When the insulating film is a silicon nitride film, the first reaction gas can be a mixed gas of N₂ gas and NH₃ gas, and the second reaction gas can be SiH₄. In this case, the step (a4) of supplying the second reaction gas may also be followed by the step of gradually reducing the N₂ gas supplied to the pair of electrodes. The step (a4) of supplying the second reaction gas may also be followed by the step of gradually increasing the NH₃ gas supplied to the pair of electrodes, instead of the step of gradually reducing the N₂ gas supplied to the pair of electrodes, or together with the step of gradually reducing the N₂ gas supplied to the pair of electrodes. The step (a4) of supplying the second reaction gas may also be followed by the steps of gradually increasing the pressure between the pair of electrodes. In this case, the insulating film in which the etching rate becomes higher towards the surface layer portion can be obtained reliably, and a tapered contact hole that narrows gradually from the surface layer portion towards the deep layer portion can therefore be formed more reliably.

### BRIEF DESCRIPTION OF THE DRAWINGS

FIG. 1 is a cross-sectional view showing a cross-section of a liquid crystal panel according to one embodiment of the present invention.

FIG. 2 is a plan view showing a color filter substrate of a liquid crystal panel according to one embodiment of the present invention.

FIG. 3 is a plan view showing an array substrate of a liquid crystal panel according to one embodiment of the present invention.

FIG. 4 is a cross-sectional view showing a cross-sectional structure of an array substrate of a liquid crystal panel according to one embodiment of the present invention.

FIG. 5 is a diagram showing a plasma CVD film forming apparatus according to one embodiment of the present invention.

FIG. 6 is a diagram showing a passivation layer formation process according to one embodiment of the present invention.

FIG. 7 is a cross-sectional view showing a comparison example of a contact hole.

FIG. 8 is a cross-sectional view showing a comparison example of a contact hole.

FIG. 9 is a diagram showing a passivation layer formation process according to another embodiment of the present invention.

FIG. 10 is a diagram showing a passivation layer formation process according to another embodiment of the present invention.

FIG. 11 is a diagram showing a passivation layer formation process according to another embodiment of the present invention.

FIG. 12 is an exploded perspective view showing an example of a liquid crystal display device.

### DETAILED DESCRIPTION OF EMBODIMENTS

Hereinafter, one embodiment of the present invention will be explained with reference to figures. It should be noted that same reference characters are given to components and portions that have substantially the same functions as the case may be. In this embodiment, a contact hole forming method will be explained using a contact hole formed in an array substrate of a liquid crystal panel as an example.

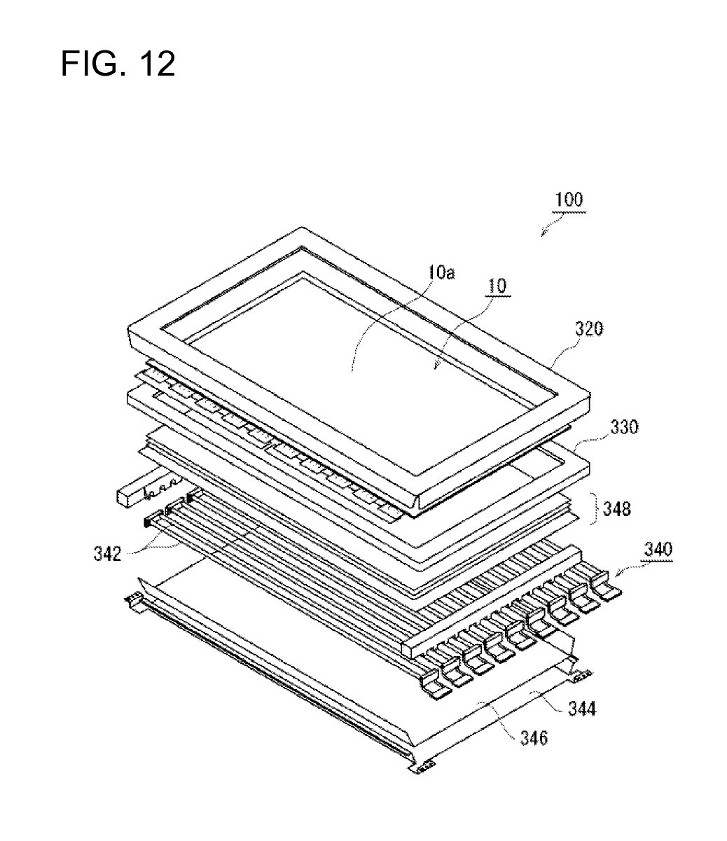

FIG. 12 is an exploded perspective view showing an example of a liquid crystal display device 100 including a liquid crystal panel 10. As shown in FIG. 12, the liquid crystal display device 100 includes a backlight device 340 facing the rear surface side of the liquid crystal panel 10. The backlight device 340 includes light sources 342 and a case (chassis) 344 that contains the light sources 342. Between the case 344 and the light sources 342, a reflection member 346 that reflects light from the light sources 342 is disposed. Between the liquid crystal panel 10 and the backlight device 340, a plurality of sheet-shape optical members 348 are laminated. Further, in the example shown in the figure, a substantially frame-shaped frame 330 is disposed so as to retain the optical members 348 by sandwiching them with the case 344. The liquid crystal panel 10 and the backlight device 340 are assembled together by a bezel (frame body) 320 and are thereby held in a unified manner. The liquid crystal panel 10 has a pixel region 10a in the center portion thereof not including the periphery. Here, a “pixel region” means a region of the liquid crystal panel 10 where pixels are formed. It should be noted that FIG. 12 merely illustrates one configuration of the liquid crystal display device 100. The liquid crystal panel 10, for which the contact hole forming method according to the present invention can be used, is not limited to the configuration shown in FIG. 12, and the method can be used for various different configurations.

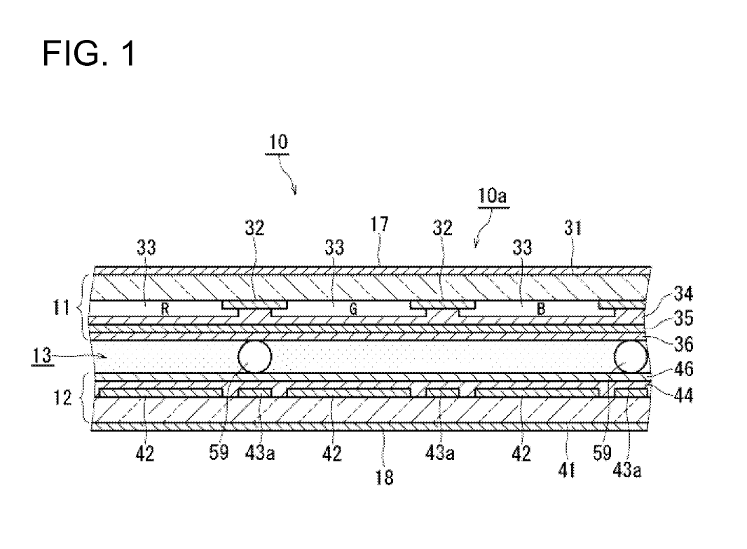

FIG. 1 shows an enlarged cross-sectional structure of the pixel region 10a of the liquid crystal panel 10. The liquid crystal panel 10 includes a pair of transparent substrates 11 and 12 (glass substrates). In this embodiment, one of the two substrates 11 and 12 is a color filter substrate 11 (CF substrate) and the other is an array substrate 12 (TFT substrate). As shown in FIG. 1, the color filter substrate 11 and the array substrate 12 are placed so as to face each other. Between the color filter substrate 11 and the array substrate 12, a sealing material (not shown) is disposed so as to surround the outer peripheral portion thereof in the circumferential directions. In a region enclosed by the color filter substrate 11, the array substrate 12, and the sealing material, a liquid crystal layer 13 is disposed, having a liquid crystal material including liquid crystal molecules sealed therein. The orientation direction of the liquid crystal molecules in such a liquid crystal material is controlled by voltages applied between the color filter substrate 11 and the array substrate 12.

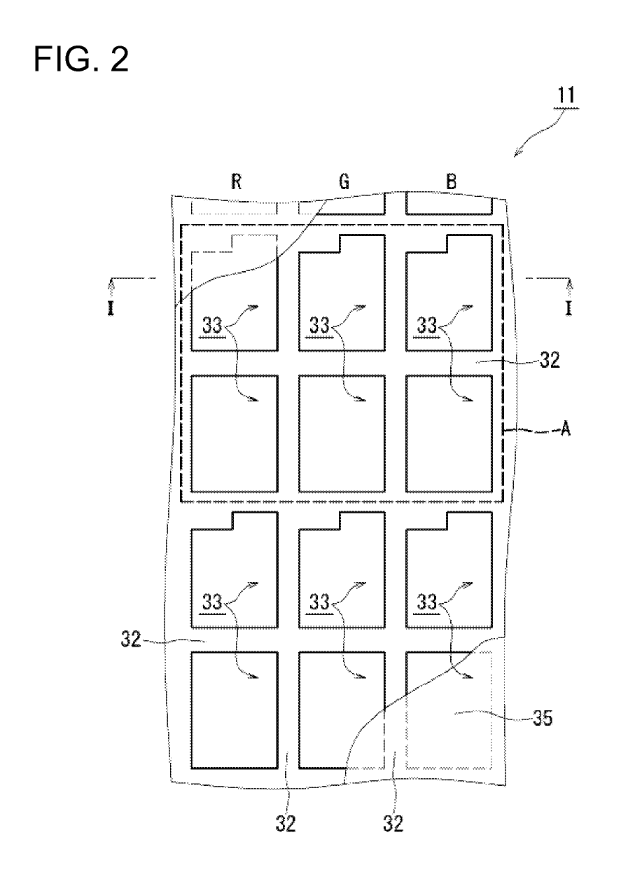

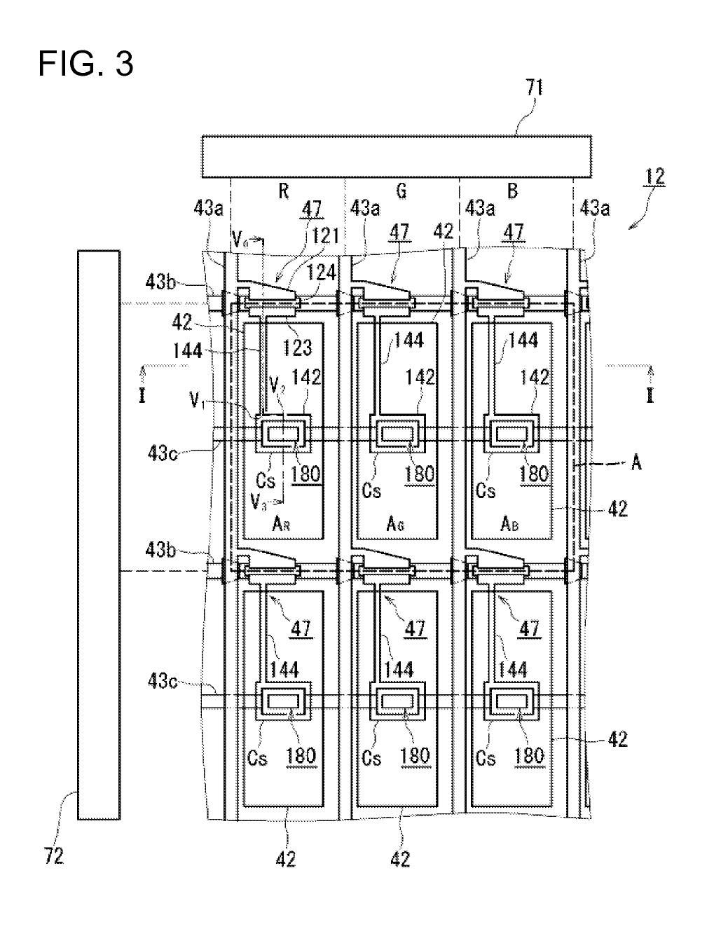

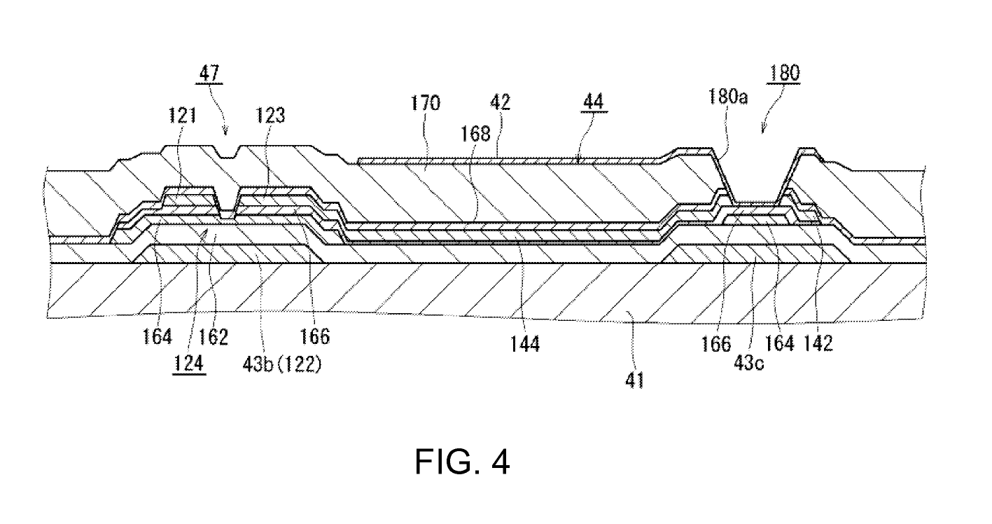

Hereinafter, the color filter substrate 11 and the array substrate 12 will be explained in turn. FIG. 2 shows a plan view of the pixel region portion of the color filter substrate 11. FIG. 3 shows a plan view of the pixel region portion of the array substrate 12. A region enclosed by the broken line A in FIGS. 2 and 3 shows a region constituting one pixel of this liquid crystal panel 10. In this liquid crystal panel 10, the pixels A shown in FIGS. 2 and 3 are arranged in row and column directions (in a matrix). FIG. 4 is a cross-sectional view schematically showing a multi-layer wiring structure of the array substrate 12. FIG. 4 shows a cross-section along the line V₀-V₃ (see FIG. 3) that runs through a lead-out wiring line 144 and an auxiliary capacitance electrode 142.

In this embodiment, as shown in FIGS. 1 and 2, the color filter substrate 11 has a black matrix 32, color filters 33, a planarizing layer 34, a common electrode 35, and an alignment film 36 (horizontal alignment film) formed on the back side of a glass substrate 31 (the liquid crystal layer 13 side, i.e., the side facing the array substrate 12). The black matrix 32 is formed of a metal such as Cr (chrome) to prevent light from passing through regions between the pixels. As shown in FIG. 2, the color filters 33 have three colors, red (R), green (G), and blue (B), and as shown in FIG. 1, one color filter 33 of red (R), green (G), or blue (B) faces one pixel electrode 42 of the array substrate 12. The planarizing layer 34 is formed so as to cover the black matrix 32 and the color filters 33 as shown in FIG. 1. The common electrode 35 made of ITO (ITO: indium tin oxide) is formed below the planarizing layer 34. The alignment film 36 made of polyimide or the like is formed below the common electrode 35.

As shown in FIGS. 1 and 3, the array substrate 12 has pixel electrodes 42, bus lines 43a to 43c, a planarizing layer 44, an alignment film 46 (horizontal alignment film), and thin film transistors 47 (TFTs) formed on the front side of a glass substrate 41 (the liquid crystal layer 13 side, i.e., the side facing the color filter substrate 11). The pixel electrodes 42 are formed of ITO, which is a transparent conductive material. Voltages corresponding to an image are supplied to these pixel electrodes 42 via the bus lines 43a to 43c and the thin film transistors 47 (see FIG. 3) at a prescribed timing. The planarizing layer 44 is formed of an insulating material. The planarizing layer 44 covers the pixel electrodes 42 and the bus lines 43a to 43c (see FIG. 3). On the planarizing layer 44, the alignment film 46 made of polyimide or the like is formed. The surface of this alignment film 46 and the surface of the alignment film 36 of the color filter substrate 11 have been alignment-treated, respectively, so as to determine the orientation direction of the liquid crystal molecules when no voltage is applied. In this embodiment, the orientation direction of the alignment film 46 of the array substrate 12 and the orientation direction of the alignment film 36 of the color filter substrate 11 are different from each other by 90°.

As shown in FIG. 1, the glass substrates 31 and 41 are disposed with spherical or circular columnar spacers 59 (spherical spacers are used in the shown example) interposed therebetween. The spacers 59 are formed of plastic, glass, or the like, for example. The gap between the glass substrates 31 and 41 is maintained by the spacers 59, and therefore, the thickness of the liquid crystal layer 13 is kept constant. Also, as shown in FIG. 1, polarizing plates 17 and 18 are bonded to the front surface side of the color filter substrate 11 (glass substrate 31) and the rear surface side of the array substrate 12 (glass substrate 41), respectively. In a liquid crystal display device of a so-called normally-white type, the directions of the polarizing axes of the two polarizing plates 17 and 18 differ from each other by 90 degrees. In a liquid crystal display device of a so-called normally-black type, the directions of the polarizing axes of the two polarizing plates 17 and 18 are the same (parallel).

Hereinafter, the array substrate 12 will be explained further. The bus lines 43a of the array substrate 12 are source bus lines (data signal lines). As shown in FIG. 3, the bus lines 43a are connected to a source driver 71 and send signals (data signals) to the sources of the thin film transistors 47. The bus lines 43b are gate bus lines (scanning signal lines). The bus lines 43b are connected to a gate driver 72 and send signals (scanning signals) to the gates of the thin film transistors 47. The bus lines 43c are bus lines of auxiliary capacitances Cs (Cs bus lines or auxiliary capacitance wiring lines). The bus lines 43c send driving signals for controlling the driving of the auxiliary capacitances Cs. In this embodiment, the source bus lines 43a respectively run down through gaps between sub-pixels A_{R}, A_{G}, and A_{B}, which are specified by R, G, and B. The gate bus lines 43b run horizontally through gaps between the sub-pixels A_{R}, A_{G}, and A_{B}, respectively. The Cs bus lines 43c run horizontally through the center portions of the sub-pixels A_{R}, A_{G}, and A_{B}, respectively.

In this embodiment, as shown in FIGS. 3 and 4, the respective sub-pixels A_{R}, A_{G}, and A_{B} have the thin film transistors 47 (TFT) disposed at respective intersections of the source bus lines 43a and the gate bus lines 43b. The thin film transistor 47 includes a source electrode 121, a gate electrode 122 (see FIG. 4), and a drain electrode 123. In this embodiment, the source electrode 121 is extended from the source bus line 43a to the position where the thin film transistor 47 is disposed. The gate electrode 122 is disposed in the gate bus line 43b. As shown in FIGS. 3 and 4, a semiconductor 124 is interposed between the source electrode 121, the gate electrode 122, and the drain electrode 123. The auxiliary capacitance Cs is constituted of the Cs bus line 43c and the auxiliary capacitance electrode 142 that faces the Cs bus line 43c through an insulating layer. The auxiliary capacitance electrodes 142 are respectively connected to the drain electrodes 123 of the thin film transistors 47 by the lead-out wiring lines 144.

As shown in FIG. 4, a wiring pattern including the gate bus line 43b and the Cs bus line 43c is formed on the glass substrate 41. On the wiring pattern including the gate bus line 43b and the Cs bus line 43c, a gate insulating film (gate insulator) 162 is formed so as to cover the entire surface. In a portion where the thin film transistor 47 is to be formed, a semiconductor layer 164 (i-Si) and an impurity layer 166 (N⁺—Si) are formed in this order on the gate insulating film 162. On the semiconductor layer 164 (i-Si) and the impurity layer 166 (N⁺—Si), the source electrode 121 and the drain electrode 123 are formed.

In a portion where the auxiliary capacitance Cs is to be formed, the semiconductor layer 164 (i-Si) and the impurity layer 166 (N⁺—Si) are formed in this order over the Cs bus line 43c through the gate insulating film 162 interposed therebetween. The impurity layer 166 (N⁺—Si) is extended and connected to the semiconductor layer 164 (i-Si) of the thin film transistor 47. On the impurity layer 166 (N⁺—Si), the auxiliary capacitance electrode 142 is formed. The auxiliary capacitance electrode 142 is connected to the drain electrode 123 by the lead-out wiring line 144 (see FIG. 3) that is extended from the drain electrode 123 of the thin film transistor 47.

Further, on this wiring structure, a passivation layer 168 (insulating film) and a resin insulating film 170 are formed in this order. The passivation layer 168 is formed by forming a film of SiOₓ or SiNₓ using the CVD method, for example. The resin insulating film 170 is formed of a resin material. By using a resin material to form the resin insulating film 170, a thick film having a high degree of transparency can be formed with ease. Also, the presence of this resin insulating film 170 can effectively suppress the generation of crosstalk that occurs when the pixel electrode 42 and the wiring lines overlap. Here, “crosstalk” refers to a leakage of the driving signal to a non-driving area. As the resin material used for the resin insulating film 170, a fluoropolymer resin (fluoropolymer) can be used, for example. Specifically, a photosensitive organic insulating film made by JSR Corporation can be used as the fluoropolymer resin.

In the portion where the auxiliary capacitance Cs is to be formed, a contact hole 180 is formed by etching the passivation layer 168 and the resin insulating film 170. The semiconductor layer 164 (i-Si) and the impurity layer 166 (N⁺—Si) formed in the auxiliary capacitance Cs function as a stopper during the etching. That is, the semiconductor layer 164 (i-Si) and the impurity layer 166 (N⁺—Si) are formed on the gate insulating film 162 that is formed on the Cs bus line 43c, and when the passivation layer 168 and the resin insulating film 170 are etched, the semiconductor layer 164 (i-Si) and the impurity layer 166 (N⁺—Si) prevent the gate insulating film 162 from being etched.

In this embodiment, as shown in FIGS. 3 and 4, the pixel electrode 42 is connected to the auxiliary capacitance electrode 142 through the contact hole 180. The position at which the contact hole 180 is formed is not limited to the position shown in the figure. That is, the pixel electrode 42 can be electrically connected to the wiring pattern at any point between the drain electrode 123 and the auxiliary capacitance electrode 142. Hereinafter, the wiring pattern between the drain electrode 123 and the auxiliary capacitance electrode 142 is referred to as a drain wiring line. The contact hole 180 can be formed in any manner as long as the connection to the drain wiring line is established, and may be formed so as to be connected to the drain electrode 123 in the portion where the thin film transistor 47 is to be formed, for example. The contact hole 180 can be formed at an appropriate position in view of a specific configuration and the like of the liquid crystal panel 10.

In this embodiment, the pixel electrode 42 is an ITO film that is a transparent metal film, and is vapor-deposited by sputtering, for example. The pixel electrode 42 is vapor-deposited on the array substrate 12. At that time, as shown in FIG. 4, the pixel electrode 42 is also vapor-deposited on the inner surface 180a of the contact hole 180. After that, as shown in FIG. 3, each pixel is separated and unnecessary portions are removed by photolithography, for example, thereby patterning each pixel electrode 42 into a desired shape.

In the array substrate 12 described above, it is preferable that the contact hole 180 be formed in a tapered shape, as shown in FIG. 4. When the inner surface 180a of the contact hole 180 is formed to have a tapered profile, ITO can be properly vapor-deposited on the inner surface of the contact hole 180 by sputtering, thereby securing the electrical connection between the drain wiring line and the pixel electrode 42.

The array substrate 12 includes a large number of thin film transistors 47, auxiliary capacitances Cs, and the like, as described above, and therefore, a very complex multi-layer wiring structure is formed therein. For example, in the array substrate 12 configured in a manner described above, the pixel electrode 42 (ITO film) is connected to the drain electrode 123 of the thin film transistor 47 (auxiliary capacitance electrode 142 in the embodiment above). To do this, the contact hole 180 is formed in an interlayer insulating film (the passivation layer 168) disposed between the drain electrode 123 of the thin film transistor 47 and the pixel electrode 42 (ITO film). In order to reduce defects of the liquid crystal panel 10, it is preferable that contact holes 180, which are formed in the array substrate 12 in large number, have a tapered shape.

In particular, in the actual production, a plurality of liquid crystal panels 10 are manufactured in a large mother glass substrate (mother glass), and the plurality of liquid crystal panels are cut out from the mother glass. As the number of panels that are cut out from one mother glass (the number of units) increases, the productivity of the liquid crystal panel is improved. Also, in applications such as televisions, televisions with a larger screen size are increasingly demanded. When the screen size becomes larger, the size of mother glass is preferably increased so that the number of units cut from the mother glass is increased and the productivity of the liquid crystal panel is therefore improved. For this reason, development of a larger mother glass has been underway. In addition, development towards high-definition with the reduced pixel pitch that can display higher definition images has also been underway. Therefore, the size of the mother glass is progressively increasing and the pixel pitch is progressively reduced to display higher definition images. As the mother glass becomes larger and as the pixel pitch becomes smaller, the number of pixels and the number of contact holes formed in one mother glass increases.

With the size increase of the mother glass, the size of manufacturing apparatuses of the liquid crystal panel is increasing. In forming the contact holes 180, for example, a CVD apparatus for forming the passivation layer 168, an etching apparatus for forming the contact hole 180, and a sputtering apparatus for forming the pixel electrode 42 are used. Such apparatuses are configured to perform prescribed processes for the entire surface of the mother glass and therefore become larger as the size of the mother glass increases. In such circumstances, in order to improve the yield, the contact holes 180, which are formed in large number in the array substrate 12, need to be formed into a tapered shape shown in FIG. 4 more reliably.

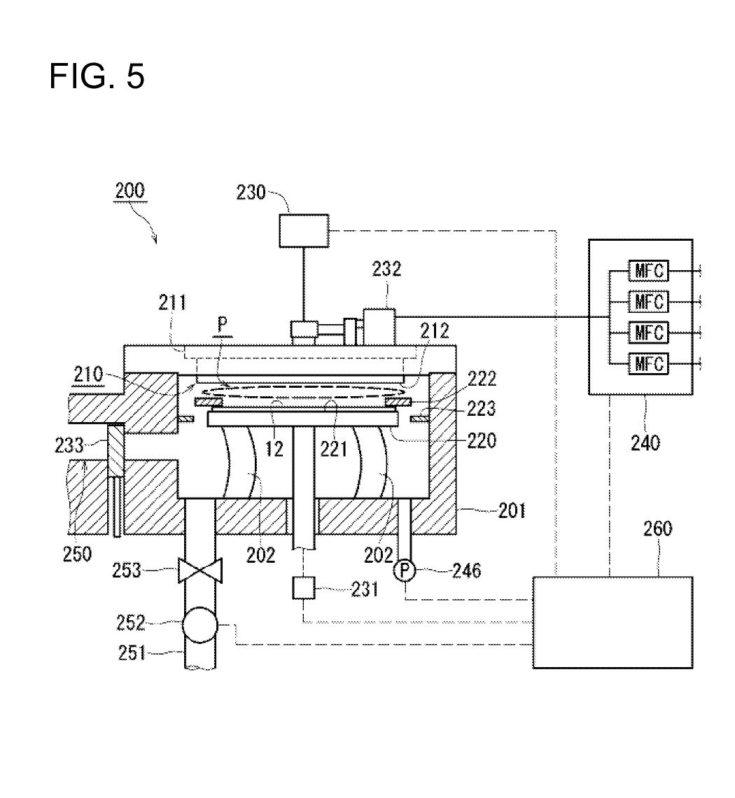

In this embodiment, the process of forming the passivation layer 168 (insulating film) in the array substrate 12 employs a plasma CVD film forming apparatus 200 that forms a film in a plasma atmosphere P generated between a pair of electrodes 210 and 220, as shown in FIG. 5.

As shown in FIG. 5, the plasma CVD film forming apparatus 200 includes a pair of upper and lower electrodes 210 and 220 disposed in a film forming chamber 201. It also includes an RF power supply 230 that supplies power to the pair of electrodes 210 and 220. The upper electrode 210 is provided with an upper electrode plate 211 and a shower head 212. The upper electrode 210 is attached to the ceiling portion of the film forming chamber 201 through an insulating material (not shown). The shower head 212 diffuses a film forming gas from the upper electrode 210 to a downward direction. The lower electrode 220 is provided with a lower electrode plate 221 that holds the array substrate 12 in which the passivation layer 168 (see FIG. 4) is formed. The lower electrode 220 is supported by a lift 231 and is therefore able to move up and down in the film forming chamber 201. The array substrate 12 is placed on the lower electrode plate 221 of the lower electrode 220. On the array substrate 12, a mask frame 222 is disposed so as to define a region in which the passivation layer 168 is to be formed. The mask frame 222 has an opening corresponding to the region in which the passivation layer 168 is to be formed on the array substrate 12. A mask frame support 223 is disposed inside of the film forming chamber 201 to support the mask frame 222 when the mask frame 222 comes down.

The film forming chamber 201 also includes ground members 202, a gas supply system 232, and a gate valve 233 that takes the array substrate in and out. The ground members 202 connect the bottom portion of the film forming chamber 201 and the lower electrode plate 221, thereby reinforcing the grounding of the lower electrode plate 221. The gas supply system 232 is equipped with a required number of mass flow controllers 240 according to the number of types of processing gases to be used. The gas supply system 232 supplies a gas controlled by the mass flow controller 240 to the film forming chamber 201. A pressure gauge 246 is provided to the film forming chamber 201 so as to control the pressure inside of the film forming chamber 201. The plasma CVD film forming apparatus 200 shown in FIG. 5 also includes an exhaust line 251 that is installed to the film forming chamber 201 and that has a main valve 252 and a pressure regulator 253. Also, between the film forming chamber 201 and a transfer chamber 250 disposed adjacent thereto, the gate valve 233 is disposed to separate the film forming chamber 201 and the transfer chamber 250. The gate valve 233 opens and closes at appropriate timings when the array substrate 12 is taken in and out of the film forming chamber 201.

This plasma CVD film forming apparatus 200 is controlled by a controlling system 260. The controlling system 260 obtains information regarding the air pressure inside of the film forming chamber 201 provided by the pressure gauge 246, for example. The controlling system 260 then regulates the mass flow controller 240 and the pressure regulator 253 based on the information on the air pressure inside of the film forming chamber 201. This way, the pressure inside of the film forming chamber 201 can be appropriately regulated. The controlling system 260 also controls the mass flow controller 240 so as to supply desired reaction gases into the film forming chamber 201 at a desired timing. In addition, the controlling system 260 controls the lift 231 so as to provide for a suitable distance between the pair of electrodes 210 and 220 as needed. The controlling system 260 also controls the RF power supply 230 to regulate the RF power (RF output).

This embodiment includes a process (a) of forming the passivation layer 168 (insulating film) on the array substrate 12, and a process (b) of forming contact holes in the passivation layer 168. The passivation layer 168 is formed by using the above-mentioned plasma CVD film forming apparatus 200.

In the process (a) of forming the passivation layer 168, the array substrate 12 is placed between the pair of electrodes 210 and 220, which is followed by a step (a2) of supplying a first reaction gas between the pair of electrodes 210 and 220, a step (a3) of raising the RF output supplied between the pair of electrodes 210 and 220 to a prescribed set value so as to generate a plasma after the step (a2), and a step (a4) of supplying a second reaction gas that forms an insulating film after the step (a3).

The first reaction gas is one of the reaction gases supplied to the film forming chamber 201 that is supplied before the plasma is generated. The passivation layer 168 is not formed by the first reaction gas alone even when the plasma is generated. On the other hand, the second reaction gas is a reaction gas that is supplied after the plasma is generated and that causes a reaction to form the passivation layer 168. When the passivation layer 168 is formed of SiNₓ as described above, an ammonia gas (NH₃ gas) or a mixed gas of an ammonia gas and a nitrogen gas (NH₃ gas+N₂ gas) is supplied into the film forming chamber 201 as the first reaction gas, and an SiH₄ gas (silicon hydride, silane) is supplied into the film forming chamber 201 as the second reaction gas.

In this embodiment, the reaction gases supplied into the film forming chamber 201 of the plasma CVD film forming apparatus 200 are divided into the first reaction gas and the second reaction gas. The first reaction gas alone does not form the passivation layer 168 made of SiNₓ even when a plasma is generated. Therefore, under the gas atmosphere of the first reaction gas, the pressure inside of the film forming chamber 201 is adjusted, and the RF power supply 230 is controlled so as to supply the RF power (RF output, high-frequency power), generating a plasma between the pair of electrodes 210 and 220. Here, the RF power (RF output; high-frequency power) preferably is gradually increased to a desired level of the RF power (RF output; high-frequency power). This way, in this embodiment, the RF output can be raised to a prescribed set value before the second reaction gas that forms the insulating film is supplied into the film forming chamber 201. In this condition, the second reaction gas that forms the insulating film is supplied to initiate the formation of the insulating film. The etching rate of the insulating film is affected by conditions such as the RF output, but in this embodiment, the conditions such as the RF output have been already adjusted when the second reaction gas is supplied, and therefore, a proper etching rate is achieved in the deep layer portion of the insulating film.

When SiH₄ is supplied to the plasma being generated as described above, the passivation layer 168 starts to form. Once SiH₄ is supplied, the passivation layer 168 gradually grows (thickens) over time.

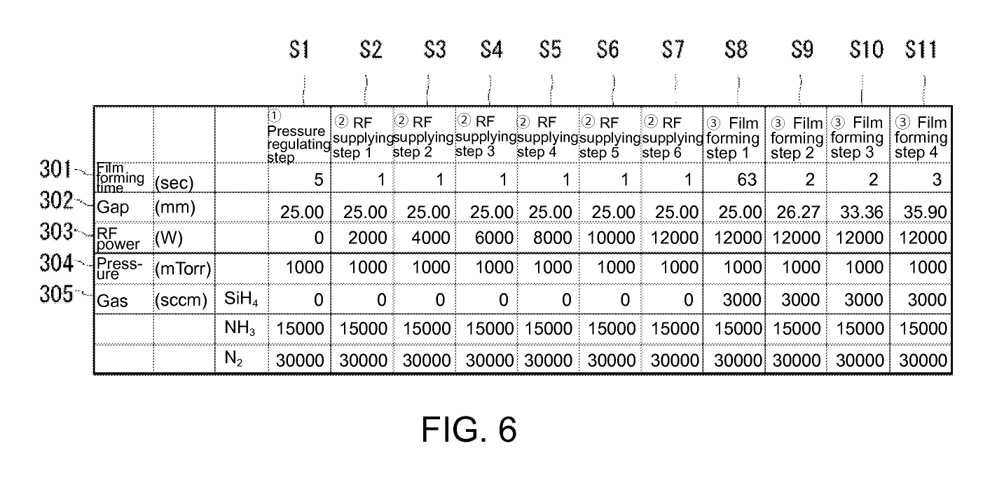

FIG. 6 is a process chart for explaining an example of a process of forming the passivation layer 168. In this embodiment, as shown in FIG. 6, the process of forming the passivation layer 168 includes a pressure regulating step (S1), RF supplying steps 1 to 6 (S2 to S7), and film forming steps 1 to 4 (S8 to S11) performed in this order. Film forming time 301 in FIG. 6 indicates the required time for each step. Gap 302 indicates the distance between the pair of upper and lower electrodes 210 and 220. RF power 303 indicates the RF output supplied to the pair of electrodes 210 and 220, and more specifically, the power supplied by the RF power supply 230. Pressure 304 indicates the pressure inside of the chamber 201. Here, the pressure 304 is measured in “Torr” where 1 Torr equals (101325/760)Pa. Gas 305 indicates components and amounts of the gases supplied into the chamber 201. Here, the supplied amount of the gas is measured in “sccm.” “Sccm” is one of the units used in vacuum apparatus to measure the flow rate of various gases when they are introduced into the vacuum apparatus. Here, “ccm” measures the flow rate in the form of cc(cm3)/min, which is cc per minute, and “sccm” is ccm that is normalized for 1 atm (atmosphere pressure 1013 hPa) and 0° C.

In the pressure regulating step (S1), the pressure inside of the chamber 201 is regulated. At that time, in the chamber 201, the distance between the pair of electrodes 210 and 220 is adjusted to 25 mm. The pressure inside of the chamber 201 is set to 1000 mTorr. The first reaction gas supplied to the chamber 201 is an ammonia gas (NH₃) and a nitrogen gas (N₂). SiH₄, which is the second reaction gas, is not supplied at this point.

Next, the RF supplying steps 1 to 6 (S2 to S7) are conducted. The RF supplying steps 1 to 6 (S2 to S7) raise the RF power, which is the RF output supplied to the pair of electrodes 210 and 220, from 2000 W to 12000 W by increments of 2000 W in every step of the RF supplying steps 1 to 6 (S2 to S7). That is, in this embodiment, the RF output supplied to the pair of electrodes 210 and 220 is raised to the prescribed set value (12000 W) in the RF supplying steps 1 to 6 (S2 to S7).

Next, the film forming steps 1 to 4 (S8 to S11) are conducted. In the film forming steps 1 to 4 (S8 to S11), the passivation layer 168 is formed. In this embodiment, the second reaction gas (SiH₄ in this embodiment) is supplied into the chamber 201 by the gas supply system 232 after the RF output has been adjusted to the prescribed set value (12000 W) by the RF supplying steps 1 to 6 (S2 to S7). In this embodiment, the passivation layer 168 is formed while the distance between the pair of electrodes 210 and 220 is increased in the film forming steps 1 to 4 (S8 to S11).

That is, in the film forming step 1 (S8), the distance between the pair of electrodes 210 and 220 is set to 25 mm. In this embodiment, the time required for the film forming steps 1 to 4 (S8 to S11) is 70 seconds in total, and the film forming step 1 (S8) accounts for 63 seconds thereof. In the film forming step 1 (S8), the foundation portion and the deep layer portion of the passivation layer 168 are formed. In the other film forming steps 2 to 4 (S9 to S11), the relatively shallow portions of the passivation layer 168 are formed. In this embodiment, the distance between the pair of electrodes 210 and 220 is increased stepwise in the remaining film forming steps 2 to 4 (S9 to S11). That is, in this embodiment, the distance between the pair of electrodes 210 and 220 is set to 25 mm in the film forming step 1 (S8). Thereafter, the distance becomes 26.27 mm in the film forming step 2 (S9), 33.36 mm in the film forming step 3 (S10), and 35.90 mm in the film forming step 4 (S11). The film forming time of the film forming step 2 (S9) and the film forming step 3 (S10) is two seconds each, and the film forming time of the film forming step 4 (S11) is three seconds. In this embodiment, time to form the passivation layer 168 while increasing the distance of the pair of electrodes 210 and 220 is about seven seconds. That is, during the last seven seconds or so of the 70 seconds that is the time required for the film forming steps 1 to 4 (S8 to S11), the passivation layer 168 is formed with the distance between the pair of electrodes 210 and 220 being increased.

According to the findings of the inventor of the present invention, in the plasma CVD film forming method, when the distance between the pair of electrodes 210 and 220 is changed during the film formation, the film density of the formed film is changed. In a nitride film, for example, it is considered that the change in the distance causes the nitrogen composition in the film to change, thereby changing the film density. In this case, as the distance between the pair of electrodes 210 and 220 becomes shorter, the film density becomes higher, and as the distance between the pair of electrodes 210 and 220 becomes longer, the film density becomes lower. As the film density becomes higher, the etching rate becomes lower (in other words, it becomes harder to etch), and as the film density becomes lower, the etching rate becomes higher (in other words, it becomes easier to etch). This means that, because the passivation layer 168 formed in the manner described above is formed while the distance between the pair of electrodes 210 and 220 is increased, the etching rate of the surface layer portion becomes higher than that of the deep layer portion. In this way, an insulating film having the film properties of being etched more easily in the surface layer portion as compared with the deep layer portion can be formed.

In the above-mentioned plasma CVD film forming apparatus 200, the operation to increase the distance between the pair of electrodes 210 and 220 can be performed by controlling the lift 231 such that the distance between the pair of electrodes 210 and 220 is adjusted appropriately as needed as shown in FIG. 5, for example. This makes it possible to reliably conduct the operation of increasing the distance between the pair of electrodes 210 and 220, and therefore, the passivation layer 168 having a higher etching rate in the surface layer portion as compared with the deep layer portion can be formed more reliably.

This passivation layer 168 has a higher etching rate in the surface layer portion as compared with the deep layer portion, and therefore, when the layer is etched in the process of forming the contact hole 180, the surface layer portion is etched more easily than the deep layer portion. Thus, the tapered contact hole 180 gradually narrowing from the surface layer portion towards the deep layer portion as shown in FIG. 4 can be formed reliably in the array substrate 12. In such a tapered contact hole 180, ITO can be vapor-deposited properly on the inner surface of the contact hole 180 by sputtering, thereby ensuring the reliable electrical connection between the drain wiring line and the pixel electrode 42.

In the pressure regulating step (S1), the pressure inside of the chamber 201 is regulated. At that time, as the first reaction gas supplied to the chamber 201, an ammonia gas (NH₃) and a nitrogen gas (N₂) are supplied. Thereafter, as shown in FIG. 6, in the RF supplying steps 1 to 6 (S2 to S7), the RF output supplied to the pair of electrodes 210 and 220 is adjusted to the prescribed set value. In such RF supplying steps 1 to 6 (S2 to S7), the only gas supplied into the film forming chamber 201 is the first reaction gas that does not form the passivation layer 168 by itself. Therefore, the passivation layer 168 is not formed in the RF supplying steps 1 to 6 (S2 to S7). After the RF output is adjusted to the prescribed set value (12000 W) in the RF supplying steps 1 to 6 (S2 to S7), the film forming steps 1 to 4 (S8 to S11) are performed, in which the second reaction gas (SiH₄) that causes the formation of the passivation layer 168 is supplied.

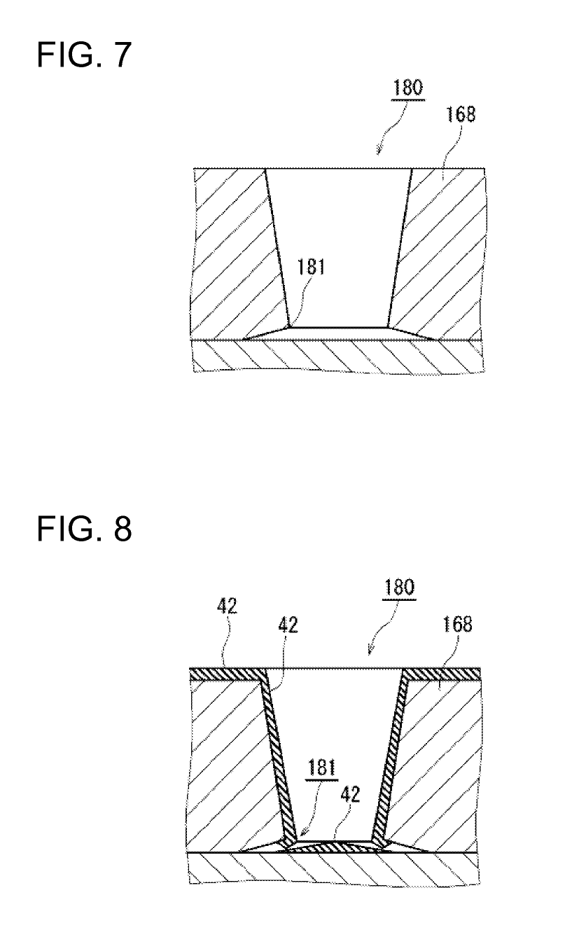

As described above, the formation of the passivation layer 168 does not start until the RF output supplied to the pair of electrodes 210 and 220 has been adjusted to the prescribed set value. Before the RF output supplied to the pair of electrodes 210 and 220 is adjusted to the prescribed set value, the plasma atmosphere P inside of the chamber 201 may not be stabilized. When the reaction gas (SiH₄) that forms the passivation layer 168 is supplied in such a condition, it may result in the passivation layer 168 unstably formed, and may result in the formation of a film having a high etching rate in the deep layer portion of the passivation layer 168. When such a film having a high etching rate is formed in the deep layer portion of the passivation layer 168, it may cause a narrower portion 181 to be formed in the middle section during the etching process for forming the contact hole 180 as shown in FIG. 7, for example. In this case, when the pixel electrode 42 is formed, the ITO film 42 may be separated inside of the contact hole 180 between the narrower portion 181 in the middle section and a portion that makes contact with the drain wiring line in the lower layer. The ITO film 42 separated by such an event creates a connection defect between the drain wiring line and the pixel electrode (ITO film).

In contrast, in this embodiment, the reaction gas (SiH₄) that forms the passivation layer 168 is not supplied until the RF output supplied to the pair of electrodes 210 and 220 has been adjusted to the prescribed set value. This prevents a film having a high etching rate from being formed in the deep layer portion of the passivation layer 168, and therefore, by etching such a passivation layer 168, the tapered contact hole 180 that narrows gradually toward the lower layer as shown in FIG. 4 can be formed more reliably. A connection defect between the drain wiring line and the pixel electrode 42 (ITO film) can therefore be prevented more reliably.

In addition, as discussed before, the mother glass of the array substrate 12 of the liquid crystal panel 10 has become larger. In the manufacturing apparatuses for the large mother glass, the plasma CVD film forming apparatus 200 that forms the passivation layer 168 has the RF output of as much as about 12000 W as described above. The RF output of the plasma CVD film forming apparatus 200 is expected to be further increased as the size of the mother glass further increases. In such a large apparatus where the plasma CVD film forming apparatus 200 has a high RF output, it can be difficult to accurately control the condition of the plasma generated in the plasma CVD film forming apparatus 200 across the entire surface of the mother glass by controlling the RF output. In this embodiment, the etching rate of the passivation layer 168 formed by the plasma CVD film forming apparatus 200 is adjusted by the distance between the pair of electrodes 210 and 220. This makes it relatively easy to accurately control the condition of the plasma generated in the plasma CVD film forming apparatus 200 across the entire surface of the mother glass, even when the size of the mother glass is further increased.

One example of the process of forming the passivation layer 168 has been explained above. As described above, in forming the passivation layer 168, if the passivation layer 168 is formed such that the etching rate becomes higher in the surface layer portion as compared with the deep layer portion, the tapered contact hole 180 that narrows gradually toward the lower layer can be formed more reliably. Other examples of the method of forming the passivation layer 168 having a higher etching rate in the surface layer portion as compared with the deep layer portion will be explained.

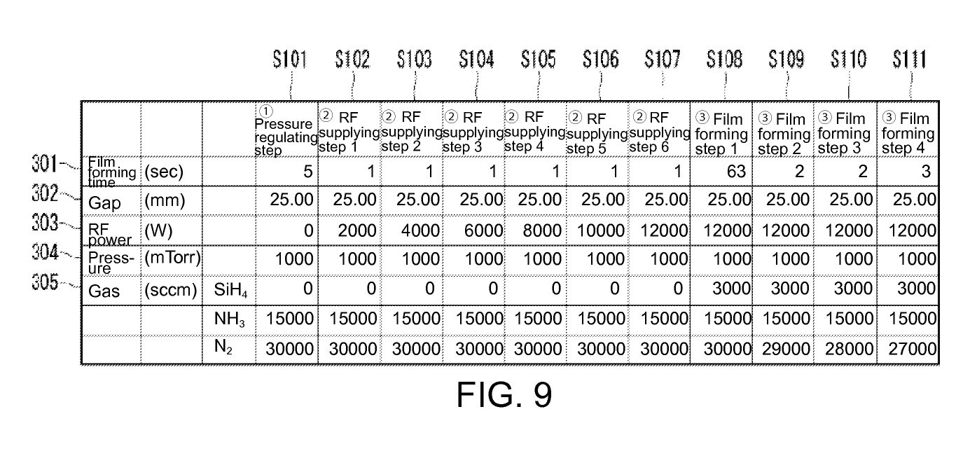

FIGS. 9 to 11 are the process charts, each of which shows an example of the process of forming the passivation layer 168. These process charts can be read in a manner similar to the process chart shown in FIG. 6. All processes shown in FIGS. 9 to 11 are similar to those in FIG. 6 except the film forming steps.

In the method shown in the process chart of FIG. 9, the N₂ gas is gradually reduced in film forming steps S108 to S111. More specifically, in this embodiment, in forming the passivation layer 168 made of a silicon nitride (SiNₓ) film, a mixed gas of N₂ gas and NH₃ gas is supplied as the first reaction gas, and SiH₄ gas is supplied as the second reaction gas, and the step (a4) of supplying the second reaction gas is followed by steps of gradually reducing the N₂ gas supplied to the pair of electrodes 210 and 220. By gradually reducing the N₂ gas supplied to the pair of electrodes 210 and 220 in the film forming steps S108 to S111 as described above, the passivation layer 168 having a higher etching rate in the surface layer portion as compared with the deep layer portion can be formed. The N₂ gas supplied to the pair of electrodes 210 and 220 can be gradually reduced by controlling the mass flow controller 240 (see FIG. 5), for example, so as to reduce the N₂ gas supplied to the pair of electrodes. In the method shown in the process chart of FIG. 9, the pressure regulating and RF supplying steps S101 to S107 are the same as the pressure regulating and RF supplying steps S1 to S7 shown in the process chart of FIG. 6.

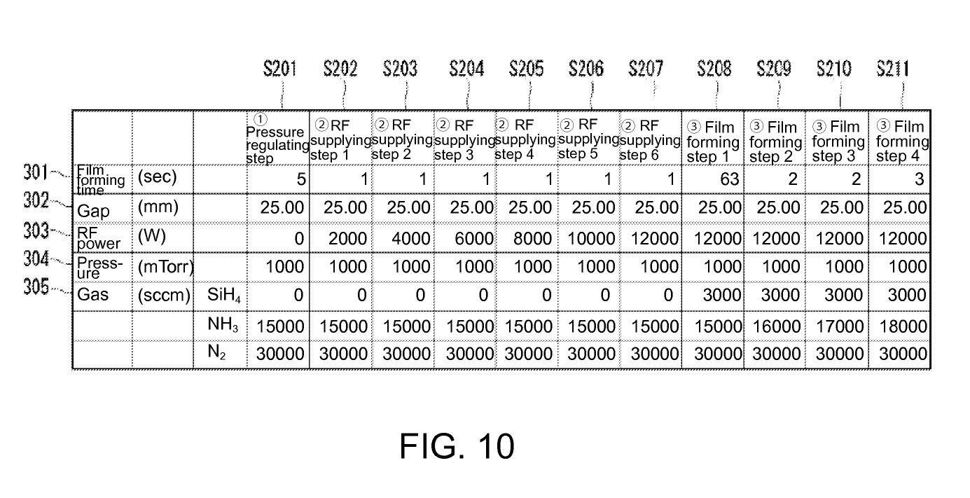

In the method shown in the process chart of FIG. 10, the NH₃ gas is gradually increased in film forming steps S208 to S211. More specifically, in this embodiment, in forming the passivation layer 168 made of a silicon nitride (SiNₓ) film, a mixed gas of N₂ gas and NH₃ gas is supplied as the first reaction gas, and SiH₄ gas is supplied as the second reaction gas, and the step (a4) of supplying the second reaction gas is followed by steps of gradually increasing the N₂ gas supplied to the pair of electrodes 210 and 220. By gradually increasing the NH₃ gas supplied to the pair of electrodes 210 and 220 in the film forming steps S208 to S211 as described above, the passivation layer 168 having a higher etching rate in the surface layer portion as compared with the deep layer portion can be formed. The NH₃ gas supplied to the pair of electrodes 210 and 220 can be gradually increased by controlling the mass flow controller 240 (see FIG. 5), for example, so as to increase the NH₃ gas supplied to the pair of electrodes. In the method shown in the process chart of FIG. 10, the pressure regulating and RF supplying steps S201 to S207 are the same as the pressure regulating and RF supplying steps S1 to S7 shown in the process chart of FIG. 6.

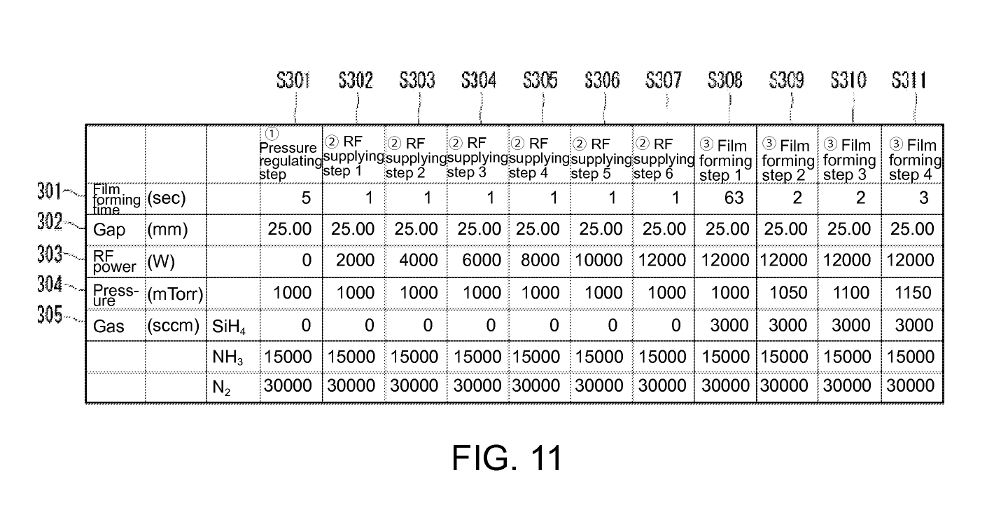

In film forming steps S308 to S311 of the process shown in FIG. 11, the pressure is gradually increased. More specifically, in this embodiment, in forming the passivation layer 168 made of a silicon nitride (SiNₓ) film, a mixed gas of N₂ gas and NH₃ gas is supplied as the first reaction gas, and SiH₄ gas is supplied as the second reaction gas, and the step (a4) of supplying the second reaction gas is followed by steps of gradually increasing the pressure between the pair of electrodes 210 and 220. By gradually increasing the pressure between the pair of electrodes 210 and 220 in the film forming steps S308 to S311 as described above, the passivation layer 168 having a higher etching rate in the surface layer portion as compared with the deep layer portion can be formed. The pressure between the pair of electrodes 210 and 220 can be increased by adjusting the pressure regulator 256 based on the information regarding to the air pressure inside of the film forming chamber 201 obtained by the pressure gauge 246, for example. In the method shown in the process chart of FIG. 11, the pressure regulating and RF supplying steps S301 to S307 are the same as the pressure regulating and RF supplying steps S1 to S7 shown in the process chart of FIG. 6.

As described above, the above-mentioned contact hole forming method includes a process (a) of forming an insulating film on a substrate and a process (b) of forming contact holes in the insulating film. In the process (a) of forming the insulating film on the substrate, a first reaction gas is supplied between a pair of electrodes where the substrate is placed (a step (a2)). Next, after the step (a2), an RF output supplied between the pair of electrodes 210 and 220 is raised to a prescribed set value to generate a plasma (a step (a3)). Next, after the step (a3), a second reaction gas that forms the insulating film is supplied (a step (a4)). This way, an insulating film can be formed after the plasma generated between the pair of electrodes 210 and 220 has been stabilized.

Also, as described above, the step (a4) of supplying the second reaction gas may be followed by the step of forming the insulating film while increasing the distance between the pair of electrodes. As a result, the insulating film having a higher etching rate in the surface layer portion as compared with the deep layer portion can be formed, and by etching such an insulating film, a tapered contact hole that narrows gradually toward the lower layer as shown in FIG. 4 can be formed more reliably.

When the insulating film is a silicon nitride film, a mixed gas of N₂ gas and NH₃ gas can be used as the first reaction gas, and SiH₄ gas can be used as the second reaction gas. In this case, the insulating film having a higher etching rate in the surface layer portion as compared with the deep layer portion can be formed by gradually reducing the N₂ gas supplied to the pair of electrodes after the step (a4) of supplying the second reaction gas. Also, the NH₃ gas supplied to the pair of electrodes may be gradually increased after the step (a4) of supplying the second reaction gas. This makes it possible to form an insulating film having a higher etching rate in the surface layer portion as compared with the deep layer portion more reliably.

When the insulating film is a silicon nitride film, and when a mixed gas of N₂ gas and NH₃ gas is used as the first reaction gas, and SiH₄ gas is used as the second reaction gas, the N₂ gas supplied to the pair of electrodes may be gradually reduced, and at the same time, the NH₃ gas supplied to the pair of electrodes may be gradually increased in the film forming steps. Also, when the insulating film is a silicon nitride film, and when a mixed gas of N₂ gas and NH₃ gas is used as the first reaction gas, and SiH₄ gas is used as the second reaction gas, the insulating film may be formed by increasing the distance between the pair of electrodes and by gradually reducing the N₂ gas supplied to the pair of electrodes during the film forming step. The insulating film may also be formed by increasing the distance between the pair of electrodes and by gradually increasing the NH₃ gas supplied to the pair of electrodes during the film forming steps.

As described above, a method of forming the insulating film while increasing the distance between the pair of electrodes, a method of gradually reducing the N₂ gas supplied to the pair of electrodes, a method of gradually increasing the NH₃ gas supplied to the pair of electrodes, and a method of gradually increasing the pressure between the pair of electrodes can be conducted in the film forming step after the second reaction gas is supplied, and all of them can contribute to forming the insulating film having a higher etching rate in the surface layer portion as compared with the deep layer portion more reliably. These methods may be used individually or may be combined appropriately in view of effects on a film pressure distribution and the like in an actual insulating film to be formed.

Hereinbefore, one mode of the present invention has been explained by using the array substrate 12 of the liquid crystal panel 10 as an example, but the present invention is not limited to the above-mentioned embodiments.

In the above-mentioned embodiments, the reaction gas (SiH₄) is supplied into the chamber 201 that includes the ammonia gas (NH₃) and the nitrogen gas (N₂), for example. In this case, an SiNₓ film is formed as the passivation layer 168. As the passivation layer 168, an SiOₓ film or a film made of both SiNₓ and SiOₓ may be formed instead. In this case, a gas inside of the chamber 201 and a reaction gas supplied during the film forming steps 1 to 4 (S8 to S11) can be appropriately selected.

The contact hole forming method according to the present invention can be used as a method of forming a contact hole in an insulating film formed on a substrate, not only for an array substrate of a liquid crystal panel, but also for various circuit substrates. Preferably, the process (a) of forming such an insulating film on a substrate uses a plasma CVD film forming method in which a film is formed under a plasma atmosphere that is generated between a pair of electrodes, and the insulating film is preferably formed while increasing the distance between the pair of electrodes. Also preferably, the process (b) of forming a contact hole in the insulating film uses etching to form the contact hole. According to such a method, the etching rate of a film formed in the surface layer portion of the insulating film becomes higher than that of the deep layer portion, and the tapered contact hole 180 that narrows toward the lower layer as shown in FIG. 4 can therefore be formed more reliably. This way, connection defects between the drain wiring line and the pixel electrode 42 (ITO film) can be prevented more reliably.

As the etching method, an appropriate method selected from various dry-etching and wet-etching methods can be used, for example. Also, in this case, it is further preferable that in the process (a) of forming the insulating film on the substrate, the reaction gas that forms the insulating film is supplied after the RF output supplied to the pair of electrodes has been adjusted to the prescribed set value. This way, the plasma generated between the pair of electrodes has been already stabilized when the formation of the insulating film starts, and therefore, a film with a high etching rate is not formed in the deep layer portion of the insulating film. This allows the tapered contact hole 180 that gradually narrows toward the lower layer as shown in FIG. 4 to be formed more reliably, thereby preventing connection defects between the drain wiring line and the pixel electrode 42 (ITO film) even more reliably.

### DESCRIPTION OF REFERENCE CHARACTERS

10 liquid crystal panel, LCP
10a pixel region
11 color filter substrate
12 array substrate
13 liquid crystal layer
17, 18 polarizing plates
31 glass substrate
32 black matrix
33 color filter
34 planarizing layer
35 common electrode
36 alignment film
41 glass substrate
42 pixel electrode (ITO film)
43a source bus line
43b gate bus line
43c Cs bus line
44 planarizing layer
46 alignment film
47 thin film transistor
59 spacer
71 source driver
72 gate driver
100 liquid crystal display device
121 source electrode
122 gate electrode
123 drain electrode
124 semiconductor
142 auxiliary capacitance electrode
144 lead-out wiring line
162 gate insulating film
164 semiconductor layer
166 impurity layer
168 passivation layer
170 resin insulating film
180 contact hole
180a inner surface of contact hole
181 narrower portion in middle section of contact hole
200 plasma CVD film forming apparatus
201 film forming chamber
202 ground member
210 upper electrode
211 upper electrode plate
212 shower head
220 lower electrode
221 lower electrode plate
222 mask frame
223 mask frame support
230 RF power supply
231 lift
232 gas supply system
233 gate valve
240 mass flow controller
246 pressure gauge
250 transfer chamber
251 exhaust line
252 main valve
253 pressure regulator
260 controlling system
320 bezel
330 frame
340 backlight device
342 light source
344 case
346 reflection member
348 optical member
Cs auxiliary capacitance
P plasma atmosphere
S1 pressure regulating step
S2 to S7 RF supplying steps 1 to 6
S8 to S11 film forming steps 1 to 4

1. A contact hole forming method, comprising:
a process (a) of forming an insulating film on a substrate; and
a process (b) of forming a contact hole in said insulating film by etching,
wherein the process (a) comprises the steps of:
(a1) placing the substrate between a pair of electrodes,
(a2) supplying a first reaction gas between the pair of electrodes having the substrate placed therebetween in the step (a1),
(a3) raising an RF output supplied between the pair of electrodes to a prescribed set value after the step (a2) so as to generate a plasma, and
(a4) supplying a second reaction gas that forms the insulating film after the step (a3).

2. The contact hole forming method according to claim 1, wherein the step (a4) of supplying the second reaction gas is followed by the step of forming the insulating film while increasing a distance between the pair of electrodes.

3. The contact hole forming method according to claim 1, wherein the insulating film is a silicon nitride film,
wherein the first reaction gas is a mixed gas of N₂ gas and NH₃ gas,
wherein the second reaction gas is SiH₄, and
wherein the step (a4) of supplying the second gas is followed by the step of gradually reducing the N₂ gas supplied between the pair of electrodes.

4. The contact hole forming method according to claim 1, wherein the insulating film is a silicon nitride film,
wherein the first reaction gas is a mixed gas of N₂ gas and NH₃ gas,
wherein the second reaction gas is SiH₄, and
wherein the step (a4) of supplying the second reaction gas is followed by the step of gradually increasing the NH₃ gas supplied between the pair of electrodes.

5. The contact hole forming method according to claim 1, wherein the step (a4) of supplying the second reaction gas is followed by the step of gradually increasing a pressure between the pair of electrodes.
